(19) United States
(12) Patent Application Publication
(10) Pub. No.: US 2008/0270319 A1
(43) Pub. Date: Oct. 30, 2008

(54) Method and System to Facilitate a User to User Subscription Based Online Marketplace for Real-Time Investment Data

(76) Inventors: Kasra Torabi, Encino, CA (US); Kasra Tajik, Los Angeles, CA (US)

Correspondence Address: INHOUSE CO., 280 COLORADO AVE., PALO ALTO, CA, 94301, US

(21) Appl. No.: 12/111,149

(22) Filed: Apr. 28, 2008

Related U.S. Application Data
(60) Provisional application No. 60/926,646, filed on Apr. 27, 2007.

(51) Int. Cl. G06Q 40/00; G06Q 30/00

(52) U.S. Cl. 705/36 R; 705/1

(57) ABSTRACT

An online marketplace for real-time investment data is disclosed. The system comprises a network, such as the Internet, wherein users may manage, and publish a Virtual Securities Portfolio (“VSP”) and to sell/license access to the VSP to other users who pay to see the VSP. VSPs are analyzed, ranked and charted according to various customizable methods and made available, via a user interface, to other users according to the users' sell/license agreements. The system further allows the users to access their investment accounts on other networks, such as the TD-Ameritrade and Charles Schwab networks, and couple their VSPs with such accounts.

### CROSS-REFERENCE TO RELATED APPLICATION

This application claims the benefit of priority under 35 U.S.C. 119(e) to the filing date of U.S. provisional patent application No. 60/926,646 entitled “System and Method For an Online Marketplace for Real-Time Investment Data” which was filed Apr. 27, 2007, and which is incorporated herein by reference.

### FIELD OF THE INVENTION

The present invention relates generally to a method and a system to establish an online marketplace for access to real-time securities trading data, and more specifically to a method and a system to facilitate a user-to-user subscription based online marketplace for access to real-time securities trading data.

### BACKGROUND OF THE INVENTION

The demand for good investment advice is always high, and has grown steadily. The investment newsletter businesses are booming. This industry generates an estimated $241 million annually. Television shows have been phenomenally successful simply offering investment advice. Also, in the last few years, online investing communities have grown remarkably. For example, Motley Fool's CAPS website claims to have a community base of over 100,000 users. Beginners recognize the danger in haphazardly speculating with their hard-earned money, and rightfully seek advice in one form or another. The need for expert guidance is only compounded in today's volatile market. High demand for expert opinion and strategies exists in every market around the world. This is especially true in emerging markets, where perceived risk is high due to lack of complete information.

Yet there are significant flaws and moral hazards with today's popular forms of investment advice. With television shows and investment newsletters, for example, one can never be certain of the true motives behind the recommendations. It is almost never disclosed if the advisor has a personal stake in the company, or if it is just a recommendation. Furthermore, performance is hardly ever tracked so investors have no accurate gauge of the recommender's ability. Online communities, as they currently operate, offer very little incentive to proficient investors to participate.

By design, the present invention addresses each these issues. Each contributor that registers has a certified trading account, either imported from their personal investing accounts or established through the present invention's virtual trading system. This allows subscribers to be absolutely certain of past investing performance by contributor.

Unlike other online investing communities, the present invention creates significant financial incentive for potential contributors. Rather than giving information away, contributors are able to charge subscription fees for access to their portfolio. Accordingly, the present invention gives subscribers various options to respond to the investment decisions or actions of the one or more contributors. Hands-on investors may decide to receive e-mails of contributor activity, opting to make all trading decisions themselves. For hands-off investors, the present invention will create a secure link between the contributor and subscriber accounts, allowing subscribers to easily replicate the trades of their chosen contributor in their own investment accounts. The subscriber will have the ability to a certain portion of their investment fund that should follow the strategy of the contributor.

### OBJECT OF THE INVENTION

Accordingly, it is an object of the invention to provide real-time user to user driven subscription access to real-time trade data.

It is also an object of the invention to provide a monetary incentive for contributor users to share their investment activity and strategies directly with interested investors, creating a new market that rewards contributor users while allowing average investors to increase their return on investment.

It is also an object of the invention to allow a user to become a “contributor” by setting up a virtual portfolio of securities holdings.

It is also an object of the invention to track each Contributor's trading data and to continuously evaluate the holdings of each portfolio, and to measure the gains, losses, and various other metrics of the portfolio, and to rank each portfolio performance within several categories, all in real time.

It is also an object of the invention to allow general information about each Contributor and each portfolio to be made available to all other users for free. Users can easily search and view this data through customizable charts and graphic tools that make it easy to find their favorite top-performing portfolio. Having found a portfolio, users can then subscribe to it for a price set by the Contributor.

It is also an object of the invention to create the first virtual stock trading site that provides effective financial incentives to participants for sharing their best stock-trading insights with others.

It is also an object of the invention to allow users to subscribe directly to individual “virtual funds,” allowing them to watch a particular investor's real-time trades as they occur.

### SUMMARY OF THE INVENTION

The present invention provides a method to facilitate a user to user subscription based online marketplace for investment data comprising: a. providing a network, b. providing a host computer system wherein the host computer system is connected to the network wherein the host computer system contains one or more contributor users wherein the contributor user provides information regarding purchase or sale of security instrument wherein the information regarding purchase or sale of security instrument is recorded, c. providing a subscription price wherein the contributor user receives the subscription price, d. providing one or more subscriber users wherein the subscriber user pays the subscription price to access the information regarding purchase or sale of security instrument.

Here the subscription price can be in the form of money, credit, airline mileage, or any negotiate instruments. The network can be any form of network such as internet, intranet, local area network, wide area network or the likes. Security instrument include but not limited to shares of corporate stock or mutual funds, bonds issued by corporations or governmental agencies, stock options or other options, limited partnership units, all commodities such as gold, silver, or the likes, currencies, and various other formal investment instruments that are negotiable and fungible.

In one embodiment, the network is an internet network. In another embodiment, the subscriber user can preview the information regarding purchase or sale of security instrument before the subscriber user pays the subscription price to access the information regarding purchase or sale of security instrument. In yet another embodiment, all standard metrics used for evaluation of the performance and risk characteristics of a mutual fund would be available to users in the preview function.

In one embodiment, the subscription price is determined by the contributor user. In another embodiment, the subscription price is determined by the contributor user wherein a maximum number of subscriber users allowed to subscribe by paying the subscription price is determined by the contributor user. In yet another embodiment, the subscription is determined by the host computer system. In one other embodiment, the subscription is determined by the host computer system based on the information regarding purchase or sale of security instrument. Specifically, the subscription is determined by the host computer system based on performance or age of the portfolio regarding purchase or sale of security instrument.

In yet another embodiment, the subscriber user is automatically matched by the host computer system to the contributor user based on the subscriber user's predetermined parameters. In yet another embodiment, the subscriber user is notified by the host computer system when the information regarding purchase or sale of security instrument is recorded. The subscriber user can be notified by SMS, email, pop-up windows, voicemail, phone calls or the likes.

In yet another embodiment, the method includes an operator wherein the operator operates the user to user subscription based online marketplace for investment data wherein the operator receives a percentage of the subscription price. In another embodiment, the operator operates the user to user subscription based online marketplace for investment data wherein the operator receives a service fee from the contributor user. In yet another embodiment, the method of further comprises providing an automated trade emulation feature wherein the automated trade feature automatically duplicates trade for the subscriber user based on the information regarding purchase or sale of security instrument. In yet another embodiment, the method allows a subscriber user who has elected to use automated portfolio emulation feature to set execution parameters including but not limited to the following: (1) the subscriber user chooses what action is to be taken by the host computer system “by default” when a notification of a trade is sent to the Subscriber, in the event that the subscriber user makes no response either indicating whether the subscriber user does or does not wish to have the trade be effected in his own brokerage account; for example, the default setting can be set to either “do not execute” or “execute,” according to the subscriber user's selection; (2) the subscriber user chooses a time interval, which time interval the system will allow to the subscriber following each trade alert, before taking the default action preselected by the subscriber.

In another aspect, the present invention provides a system to facilitate a user to user subscription based online marketplace for investment data comprising: (a) a network, (b) a host computer system wherein the host computer system is connected to the network wherein the host computer system contains one or more contributor users wherein the contributor user provides information regarding purchase or sale of security instrument wherein the information regarding purchase or sale of security instrument is recorded, (c) a subscription price wherein the contributor user receives the subscription price, (d) one or more subscriber users wherein the subscriber user pays the subscription price to access the information regarding purchase or sale of security instrument.

In one embodiment, the network is an internet network. In another embodiment, the subscriber user can preview the information regarding purchase or sale of security instrument before the subscriber user pays the subscription price to access the information regarding purchase or sale of security instrument.

In yet one aspect of the present invention a system to facilitate a user to user subscription based online marketplace for investment data is disclosed which is comprised of: a. a network, b. one or more users, c. one or more contributors wherein the contributors is an user wherein the contributor manages a securities portfolio, d. a subscription price wherein the contributor receives the subscription price, e. one or more subscribers wherein the subscriber is an user wherein the subscriber pays the subscription price to access the contributor's securities portfolio, f. a host computer system wherein the host computer system is connected to the network wherein the host computer system hosts an information exchange system comprising: (1) an account management module wherein the account management module manages the user's information, (2) a profile management module wherein the profile management module provides preview information regarding the contributor's securities portfolio regarding purchase or sale of security instrument, (3) a data module wherein the data module updates the contributor's securities portfolio, (4) an input module wherein the trade input module provides contributor's trading data regarding the contributor's purchase or sale of security instrument to the data module.

In one embodiment, a contributor's securities portfolio may be purely comprised of other portfolios, and in another embodiment a portfolio is comprised of securities and other portfolios. Yet in another embodiment, each user is assigned a portfolio.

In yet another embodiment, the system allows multiple contributors to “team up” to contribute live trade data to a composite portfolio, in which each contributor manages a certain, agreed upon proportion of the composite portfolio's total holdings. IOE, the system allocates subscription money earned through the composite portfolio to each of that portfolio's contributing contributors pro-rata, according to the proportion of the composite portfolio which is managed by each such contributor.

In yet another embodiment, the host computer system gathers trading data from the contributor's online brokerage accounts to establish the contributor's securities portfolio before the contributor's participation in the system. In yet another embodiment, the system allows each contributor to choose a unique portfolio identifier (a “UPI”), which UPI comprises a unique string of alphanumeric characters or symbols, which UPI the system associates with one of the contributor's securities portfolios. In one other embodiment, the system presents one or more UPIs to users, allowing users to search for portfolios based on UPIs, and also allowing the UPIs to be presented as a “ticker” similar to those used to display stock symbols.

In another embodiment, the subscriber can subscribe to multiple contributor's securities portfolios. In one embodiment, the input module is comprised of a graphic user interface wherein the contributor enters the contributor's trading through the graphic user interface. In yet another embodiment, the input module is comprised of a client application installed at the contributor's work station wherein the client application retrieves input fields of the contributor's online brokerage service. In one other embodiment, the system further comprises a validation module wherein the validation module validates the trading data is provided to the data module. The validation module can be comprised of: a. contributor's trading data, b. a third party agent capable of collecting real-time security price information, c. a verification module wherein the verification module verifies the contributor's trading data using the real-time security price information and a verification business rule.

In yet another embodiment, the verification business rule is comprised of: a. retrieving a quantity of security shares purchased from the trading data, b. retrieving time of trade from the trading data, c. determining security pricing at the time of trade using security price information provided by the third party agent, d. multiplying the quantity of security shares purchased by the security price determined by third party agent at the time of trade to determine a cash requirement, e. comparing the cash requirement to the contributor's securities portfolio to determine whether the contributor's securities portfolio has sufficient funds to execute the purchase of quantity of security shares.

In yet another embodiment, the verification business rule is comprised of: a. retrieving a quantity security of shares sold from the trading data, b. comparing the quantity of shares sold with the contributor's securities portfolio to determine whether the contributor's securities portfolio has sufficient shares to execute the sale of quantity of security shares.

In a prefer embodiment, the system is further comprised providing a news updating module. In yet another embodiment, the preview information is comprised of: a. providing ranking information regarding the contributor's securities portfolio as compared to other contributor's securities portfolio, b. providing risk ratings regarding the contributor's securities portfolio, c. providing security holding summary regarding the contributor's securities portfolio, and d. providing investment summary regarding contributor's securities portfolio.

The system can also include a portfolio ranking module and or a portfolio analysis module. In one embodiment, the subscription price is determined by the contributor. In another embodiment, the subscription price is determined by the contributor wherein a maximum number of subscribers allowed to subscribe by paying the subscription price is determined by the contributor. In yet another embodiment, the subscription price is determined by the host computer system. In one other embodiment, the subscription price is determined by the host computer system based on the contributor's securities portfolio.

In yet another embodiment, the system can calculate a suggested subscription price (the “GSSP”) for each contributor's securities portfolio, where the GSSP is based on an appraisal of one or more metrics calculated for the portfolio, which metrics may include, but are not limited to, the performance of the portfolio over an arbitrary period of time, the subscription prices set for other portfolios having holdings similar to the portfolio, subscriber ratings of the portfolio's controlling contributor.

In one other embodiment, the subscriber is automatically matched by the host computer system to the contributor based on the subscriber's predetermined parameters. In one other embodiment, the subscriber is notified by the host computer system when the contributor's securities portfolio is changed. An example of change of portfolio is when certain securities in the portfolio is sold or purchased. In one other embodiment, the system further includes an operator wherein the operator operates the user to user subscription based online marketplace for investment data wherein the operator receives a percentage of the subscription price. In yet one other embodiment, the system includes an operator wherein the operator operates the user to user subscription based online marketplace for investment data wherein the operator receives a service fee from the contributor. An example of service fee is based where there is a service fee for each subscriber that subscribes the contributor's securities portfolio. In yet a preferred embodiment, the system further includes an automated trade emulation feature wherein the automated trade feature automatically duplicates trade for the subscriber based on changes to the contributor's securities portfolio. In yet another embodiment, the system allows a subscriber who has elected to use automated portfolio emulation feature to set execution parameters including but not limited to the following: (1) the subscriber chooses what action is to be taken by the host computer system “by default” when a notification of a trade is sent to the subscriber, in the event that the subscriber user makes no response either indicating whether the subscriber does or does not wish to have the trade be effected in his own brokerage account; for example, the default setting can be set to either “do not execute” or “execute,” according to the subscriber user's selection; (2) the subscriber chooses a time interval, which time interval the system will allow to the subscriber following each trade alert, before taking the default action preselected by the subscriber. In yet another embodiment, the system allows a subscriber who has elected to use automated portfolio emulation the option to either allow or disallow pre-market and after-market trading (limit orders). In yet another embodiment, the subscribers who have elected to use automated portfolio emulation can specify certain types of investments, such as particular stocks or classes of securities to be excluded from automatic emulation. In yet another embodiment, the subscribers can designate certain securities holdings as securities which are never to be sold through automated portfolio emulation. In yet another embodiment, a subscriber who has elected to use automated portfolio emulation, with various options relating to the ability of the system to effect automatic trades by causing the subscriber's online brokerage to lend money (trade on margin) to effectuate the trade.

In one other aspect of the invention, a method to facilitate a user to user subscription based online marketplace for investment data comprising: a. providing a network, b. providing one or more users, c. providing one or more contributors wherein the contributors is an user wherein the contributor manages a securities portfolio, d. providing a subscription price wherein the contributor receives the subscription price, e. providing one or more subscribers wherein the subscriber is an user wherein the subscriber pays the subscription price to access the contributor's securities portfolio, f. providing a host computer system wherein the host computer system is connected to the network wherein the host computer system hosts an information exchange system comprising: (1) an account management module wherein the account management module manages the user's information, (2) a profile management module wherein the profile management module provides preview information regarding the contributor's securities portfolio regarding purchase or sale of security instrument, (3) a data module wherein the data module updates the contributor's securities portfolio, (4) an input module wherein the trade input module provides contributor's trading data regarding the contributor's purchase or sale of security instrument to the data module.

In one embodiment, the input module is comprised of a graphic user interface wherein the contributor enters the contributor's trading through the graphic user interface. In another embodiment, the input module is comprised of a client application installed at the contributor's work station wherein the client application retrieves input fields of the contributor's online brokerage service. In yet another embodiment, the method contains a validation module wherein the validation module validates the trading data is provided to the data module. The validation module may contain a. contributor's trading data, b. a third party agent capable of collecting real-time security price information, c. a verification module wherein the verification module verifies the contributor's trading data using the real-time security price information and a verification business rule. In one embodiment, the method further provides a news updating module. Alternatively, the preview information can be comprised of a. providing ranking information regarding the contributor's securities portfolio as compared to other contributor's securities portfolio, b. providing risk ratings regarding the contributor's securities portfolio, c. providing security holding summary regarding the contributor's securities portfolio, and d. providing investment summary regarding contributor's securities portfolio. The method can further be comprised of portfolio ranking module and a portfolio analysis module.

In yet another aspect of the invention, a method to verify a user's trading information in an online investment community is provided comprising: a. providing user's trading data, b. providing a third party agent capable of collecting real-time securities price information, c. providing a verification module wherein the verification module verifies user's trading data using the real-time security price information and a verification business rule. The verification business rule can be comprised of: a. retrieving a quantity of security shares purchased from the user trading data, b. retrieving a time of trade from the user trading data, c. determining a security pricing at the time of trade using security price information provided by the third party agent, d. multiplying the quantity of security shares purchased by the security price determined at the time of trade provided by the third party agent to determine a cash requirement, and e. comparing the cash requirement to the contributor's securities portfolio to determine whether the contributor's securities portfolio has sufficient funds to execute the purchase of the quantity of security shares. Likewise, a business rule can be comprised of: a. retrieving a quantity of shares sold from the user's trading data, b. comparing the quantity of shares sold with the contributor's securities portfolio to determine whether the contributor's securities portfolio has sufficient shares to execute the quantity of security shares.

In yet another preferred aspect of the present invention, a system to verify a user's trading information in an online investment community is provide comprising: In one other embodiment, the business rule is comprised of: a. retrieving a quantity of shares sold from the user's trading data, b. comparing the quantity of shares sold with the contributor's securities portfolio to determine whether the contributor's securities portfolio has sufficient shares to execute the sale of the quantity of security shares.

In yet one other preferred aspect of the invention, a system to facilitate a user to user subscription based online stock trading community is provided which is comprised of: a. a network, b. one or more participants, c. one or more contributors wherein the contributor is a participant wherein the contributors manages a virtual securities portfolio, d. a subscription price wherein the contributor receives the subscription price, e. one or more subscribers wherein the subscriber is a participant wherein the subscriber pays the subscription price to view the virtual securities portfolio, f. a host computer system wherein the host computer system is connected to the network wherein the host computer system hosts an information exchange system comprising:

(1) an account management module wherein the account management module manages the participant's account information, (2) a registration module wherein the registration collects visitor data and transmits the visitor data to a profile management module, (3) a profile management module wherein the profile management module manages the participant's profile, (4) a data module wherein the data module utilizes a trade request to update the contributor's virtual securities portfolio, (5) an input module wherein the trade input module provides contributor's trading data regarding contributor's purchase or sale of security instrument to a trade processing module, (6) a trade processing module wherein the trade processing module process the contributor's trading data to generate a trade request wherein the trade request is transmitted to the data module.

In one embodiment, the input module is comprised of a graphic user interface wherein the contributor enters the contributor's trading data through the graphic user interface.

In one other embodiment, the input module is comprised of a client application installed at the contributor's work station wherein the client application retrieves input fields of the contributor's online brokerage service. In one aspect the system contains a news updating module. In one other aspect the subscriber can preview the contributor's virtual securities portfolio before paying for the subscription price.

In one embodiment, the subscription price is determined by the contributor. In one other embodiment, the subscription price is determined by the contributor wherein a maximum number of subscribers allowed to subscribe by paying the subscription price is determined by the contributor. In yet another embodiment, the subscription price is determined by the host computer system. In yet one other embodiment, the subscription price is determined by the host computer system based on the virtual securities portfolio. An example would be that the subscription price is based on the performance or age of the virtual securities portfolio.

In another embodiment, the subscriber is automatically matched by the host computer system to the contributor based on the subscriber's predetermined parameters. In one other embodiment, the subscriber is notified by the host computer system when the virtual securities portfolio is changed. In yet another embodiment, the system includes an operator wherein the operator operates the user to user subscription based online marketplace for investment data wherein the operator receives a percentage of the subscription price. In yet another embodiment, the operator operates the user to user subscription based online marketplace for investment data wherein the operator receives a service fee from the contributor. In a prefer embodiment, the system further includes an automated trade emulation feature wherein the automated trade feature automatically duplicates trade for the subscriber based on changes to the virtual securities portfolio.

In yet one other aspect of the invention, a method to facilitate a user to user subscription based online stock trading community comprising: a. providing a network, b. providing one or more participants, c. providing one or more contributors wherein the contributor is a participant wherein the contributors manages a virtual securities portfolio, d. providing a subscription price wherein the contributor receives the subscription price, e. providing one or more subscribers wherein the subscriber is a participant wherein the subscriber pays the subscription price to view the virtual securities portfolio, f. providing a host computer system wherein the host computer system is connected to the network wherein the host computer system hosts an information exchange system comprising: (1) an account management module wherein the account management module manages the participant's account information, (2) a registration module wherein the registration collects visitor data and transmits the visitor data to a profile management module, (3) a profile management module wherein the profile management module manages the participant's profile, (4) a data module wherein the data module utilizes a trade request to update the contributor's virtual securities portfolio, (5) an input module wherein the trade input module provides contributor's trading data regarding contributor's purchase or sale of security instrument to a trade processing module, (6) a trade processing module wherein the trade processing module process the contributor's trading data to generate a trade request wherein the trade request is transmitted to the data module.

In one embodiment, the input module is comprised of a graphic user interface wherein the contributor enters the contributor's trading data through the graphic user interface. In one other embodiment, the input module is comprised of a client application installed at the contributor's work station wherein the client application retrieves input fields of the contributor's online brokerage service. The method can further provide a news updating module. Likewise, the method may allow subscriber to preview the contributor's virtual securities portfolio before paying for the subscription price.

In yet another aspect of the present invention discloses a user to user subscription based online marketplace for access of data. The embodiment of the present invention encompasses systems such as the system described herein, wherein the type of data set to which the subscriber users gain access is comprised of SMS messages, XML, machine level instructions, text messages, photos, digital audio, MIDI, hardware control data, software calls, webcam video, live video, live audio, weather data, data sent by satellite, raw data of any format, software, ringtones, rich media, hexadecimal data, animation, flash video, HTML, and the likes.

Specifically, in one embodiment, a method to facilitate a user to user subscription based online marketplace for access of data is disclosed which comprises: a. providing a network, b. providing a host computer system wherein the host computer system is connected to the network wherein the host computer system contains one or more contributor users wherein the contributor user provides a set of data, c. providing a subscription price wherein the contributor user receives the subscription price, d. providing one or more subscriber users wherein the subscriber user pays the subscription price to access the set of data. In one embodiment, the network is an internet network. In another embodiment, the subscriber user can preview the set of data before the subscriber user pays the subscription price to access the set of data.

In yet another embodiment, the subscription price is determined by the contributor user. In a preferred embodiment, the subscription price is determined by the contributor user wherein a maximum number of subscriber users allowed to subscribe by paying the subscription price is determined by the contributor user. In yet one other embodiment, the subscription is determined by the host computer system. In a preferred embodiment, the subscriber user is automatically matched by the host computer system to the contributor user based on the subscriber user's predetermined parameters.

Further, in yet one other embodiment, the method furthers an operator wherein the operator operates the user to user subscription based online marketplace for access of data wherein the operator receives a percentage of the subscription price. In one other embodiment, the method provides an operator wherein the operator operates the user to user subscription based for access of data wherein the operator receives a service fee from the contributor user.

In yet another aspect of the present invention, a system to facilitate a user to user subscription based online marketplace for access of data is disclosed comprising: a. a network, b. a host computer system wherein the host computer system is connected to the network wherein the host computer system contains one or more contributor users wherein the contributor user provides a set of data, c. a subscription price wherein the contributor user receives the subscription price, d. one or more subscriber users wherein the subscriber user pays the subscription price to access the set of data. In one embodiment the network is an internet network.

In one other embodiment, the subscriber user can preview the set of data before the subscriber user pays the subscription price to access the set of data. In one other embodiment, the subscription price is determined by the contributor user. In one other embodiment, the subscription price is determined by the contributor user wherein a maximum number of subscriber users allowed to subscribe by paying the subscription price is determined by the contributor user.

In one other embodiment, the subscription is determined by the host computer system. In one other embodiment, the subscriber user is automatically matched by the host computer system to the contributor user based on the subscriber user's predetermined parameters. In one other embodiment, the system further comprises an operator wherein the operator operates the user to user subscription based online marketplace for access of data wherein the operator receives a percentage of the subscription price. In one other preferred embodiment, the system further comprises an operator wherein the operator operates the user to user subscription based for access of data wherein the operator receives a service fee from the contributor user. In yet another embodiment, this invention also encompasses a subscription based user to user marketplace for access of data in which the data is provided by the subscriber user to the contributor user, as opposed to the other way around, where the subscriber user pays a subscription fee to other contributor users for the contributor users to accept data from the subscriber users for the purpose of storing the subscriber users' data at the contributor users' workstation or the likes. This would allow, for example, contributor users with extra storage space to charge subscriber users a subscription fee in order to participate in a distributed, redundant data storage space pool.

### BRIEF DESCRIPTION OF THE DRAWINGS

The present invention will be understood and appreciated more fully from the following detailed description taken in conjunction with the drawings in which:

FIG. 1 is a system diagram illustrating the present invention wherein the diagram discloses the apparatus of present invention comprising a user to user subscription based marketplace for investment data comprising a network, a host computer system, one or more contributor users, and one or more subscriber users.

FIG. 2 is a system diagram of FIG. 1 where user to user subscription based marketplace further includes a preview module.

FIG. 3 is a system diagram of FIG. 2 where user to user subscription based marketplace further includes various embodiments.

FIG. 4 is a system diagram of another embodiment of a user to user subscription based marketplace where the system discloses an account management module, a trade input module, a data module, a contributor's securities portfolio, one or more contributors and one or more subscribers.

FIG. 5 is a system diagram of FIG. 3 where the user to user subscription based marketplace further includes a client application installed at the contributor's workstation.

FIG. 6 is a system diagram of FIG. 3 where the user to user subscription based marketplace further includes a graphic user interface module.

FIG. 7 is a system diagram of FIG. 3 where the user to user subscription based marketplace further includes a validation module.

FIG. 8 is a diagram illustrating one embodiment of the verification business rule.

FIG. 9 is a diagram illustrating another embodiment of the verification business rule.

FIG. 10 is a system diagram of another embodiment of a user to user subscription based marketplace where the system discloses an account management module, a trade processing module, a registration agent, a portfolio management module, a contributor virtual securities portfolio, GDT module (data module), a VSP updater, a VSP Ranker, a VSP analyzer, one or more contributor and one or more subscriber.

### DETAILED DESCRIPTION OF EMBODIMENTS

The present invention discloses a real-time user to user driven subscription access to verified virtual investment information. This invention (the system) provides a monetary incentive for users to contribute their investing insights directly to interested investors, creating a new market that rewards contributor users while allowing the average person to replicate their superior return on investments.

In one embodiment, this system allows any user to become a “contributor” by setting up a virtual portfolio of securities holdings. The term “contributor” is interchangeable with the term “contributor user.” Securities include shares of corporate stock or mutual funds, bonds issued by corporations or governmental agencies, stock options or other options, limited partnership units, all commodities such as gold, silver, or the likes, currencies, and various other formal investment instruments that are negotiable and fungible. The system tracks each contributor's trading data and ranks portfolio performance within several categories, all in real time. Some general information about each contributor and each portfolio is made available to all other users for free. Users can easily search and view this data through customizable charts and graphic tools that make it easy to find their favorite top performing portfolio. Having found a portfolio, users can then subscribe to it for a price set by the contributor.

Subscribers gain access to the contributor's real-time trading data along with rankings, charts, and analyses, and can easily replicate the trades of their chosen Contributor in their own investment accounts. The term “subscriber” is interchangeable with the term “subscriber user.”

This system will be accessible across all internet and mobile platforms. As the “information broker” for this lively market, the operator of the system will collect a finder's fee. This is in addition to substantial advertising dollars from a broad spectrum of investment industry and securities-related firms.

This system will create the first virtual stock trading site that provides effective financial incentives to participants for sharing their best stock-trading insights with others. This system achieves this goal by allowing users to subscribe directly to individual “virtual funds,” allowing them to watch a particular investor's real-time trades as they occur. The subscription payments directly compensate the fund managers, with the operator of this system receiving a flat fee per subscription plus a percentage of the subscription premium or the likes. Furthermore, this system allows demand driven subscription pricing, giving fund managers autonomy on their portfolio pricing strategy.

Accordingly, the present invention allows an internet user to build, manage, and publish a Virtual Securities Portfolio (“VSP”) (contributor's securities portfolio) and to sell access to the VSP to other users who pay to see the VSP.

Specifically, the present invention allows each contributor to sell “subscriptions” to their VSPs for prices set by each contributor. The present invention presents each “Subscriber” with the real-time trading data of the VSPs to which he or she subscribes, along with trading history, rankings, charts, and analyses.

The system then makes some general information about each VSP and contributor available to other users for free. The system then presents each “subscriber” with the real-time trading data of the VSPs to which he or she subscribes, along with trading history, rankings, charts, and analyses.

Typically a visitor is an internet user who accesses the present invention via the internet. A participant would be a visitor who has completed the registration process. A participant may be a subscriber, a contributor, or both. Each participant owns a profile. A subscriber would be a participant who has an active subscription linked to one or more VSPs. Each Subscriber is associated with a unique profile and participant account. A contributor would be a participant who owns and manages a VSP. Each contributor is associated with a unique profile, a participant account, and one or more VSP. A participant account is a data set managed by the account management module, including some or all of the following fields: Active Subscriptions, Target VSP, Price and payment schedule for each subscription, subscriber's billing information such as PayPal, credit card, billing address and subscription order history which includes a list of purchased subscriptions and automatic replenish setting (on or off) as well as cash balance in the account for the subscription.

In one embodiment, the system of the invention provides the registration process as the following: 1. Visitor enters the system via the network 2. Visitor clicks on “Register” button or similar link 3. Graphic user interface then relays registration request to a Registration module, 4. Registration module queries Visitor for, and Visitor provides: a. Unique Screen Name, b. Password, c. Email address and 5 the visitor decides the desired type of Profile (Subscriber or Contributor) or the likes.

Next the registration agent collects visitor data and then the registration agent sends visitor data to a profile management module.

Once an account is set up, an account management module is a module that manages participant accounts and performs the tasks of a) Subscription start and termination, b) system Cash accounting, c) Withdrawals to cash, by check or auto-deposit, d) Auto replenish from bank or credit card, e) Credit card requests and authorizations, f) PayPal requests and authorizations and or the likes

A profile management module is an module that manages participant profiles and performs the tasks of a) Registration of new Participants, b) Creation and Deletion of Participant Profiles, c) Modification of Participant Profiles, d) Searching of Participant Profiles, e) Automatic Update of Participant Profiles which includes 1) RSS feed which is based update of Blog and 2) a preview of the contributor's securities portfolio which includes A) “Similarity to Visitor” indicators, which shows how similar the holdings, risk ratings, and stated goals of the Participant's VSP are to those of the Visitor viewing the Profile, B) Global Rank indicator which Shows the rank of the Participant's VSP compared to all VSPs in the system's universe, as of the time the visitors view the Profile, C) Contributor specified Rank Indicator which Shows the rank of the Participant's VSP compared to a set of VSP's defined by Contributor-chosen parameters such as Comparative Performance Chart, Shows the performance of the particular VSP as compared to any Visitor-selected set of VSPs, including predefined VSPs that reflect the DJIA, S&P 500, and other benchmarks.

Once the contributor intends to provide the trading information to the system, the information is fed to a trade processing module. The raw live trade data can be fed the trade processing module based on the following one of two methods: The first method is by a manual process. Here the contributor makes trades through his online brokerage or brokers, and thereafter the contributor can input the trading data through the graphic user interface of the system of the present invention. Here, the contributors types in the total number of shares into the correct row of the table and selects Buy/Sell before the information is fed to the trade processing module.

The second method is automatic feeding of information from the contributor to the trade processing module. This is achieved by a client application installed at the contributor's remote work station. Specifically, to reduce time for contributor to input their trades to the system, the system of the present invention further provides a client application for real-time reporting of online trades which is a client application which is optionally installed on each contributor's remote station to allow automatic update of the contributor's VSP using live trade request data. The data is securely read from the input fields of the graphic user interface of the contributor's online brokerage service as it is entered by the contributor. This can be done by an HTML parser. No information other than the trade information is ever transmitted to system.

The information from both methods is raw live data which is processed by the trade processing module. The trade processing module processes raw live trade data by associating each trade with the following metadata to create a Live Trade Request (LTR): a) Contributor Identifier, b) Source (automatic feed or manual), c) Action (Buy or Sell), d) Security traded, e) Quantity traded (in shares or fractional shares), f) Effective time of trade. Then the Live Trade Request (LTR) is sent to the VSP updater module in order of effective time of trade.

The VSP updater module receives LTRs then it retrieves VSP values from the appropriate VSP storage object held in the data module and then the VSP updater module will evaluates the LTR's validity.

For a Buy trade data LTR, the VSP updater module retrieves real-time securities price information from the iYahoo agent or other 3^{rd} party agent capable of collecting such information from the web, for the effective time of the LTR, and then multiplies the quantity by the security price to determine the cash requirement, which is appended as metadata to the Buy LTR. The validation module then compares the cash requirement to the value in the VSP available cash field to determine whether the VSP has sufficient virtual funds to execute the Buy LTR.

For a Sell LTR, the VSP updater module determines the quantity of shares in the VSP holdings field for the LTR's specified security, to determine whether the VSP has sufficient shares of the security to execute the Sell LTR.

And If the LTR is invalid, for example because it calls for the sale of a security that is not part of the VSP holdings field, or exceeds the quantity of the security reflected in the VSP holdings field, the VSP updater performs the following steps: 1) Sends a “failed trade” notification to the graphic user interface, 2) ignores the invalid LTR and also takes one of the following steps: a) according to Contributor-specified error handling settings, thus b) attempts to process all subsequent LTRs as usual, c) attempts to process only subsequent LTRs that affect other securities.

And when a Buy LTR fails due to lack of virtual funds in the VSP, suspends processing of all subsequent Buy LTRs until one or more Sell LTRs are processed resulting in a sufficient amount of virtual funds to complete the failed Buy LTR.

If the LTR is valid, the VSP updater processes the valid LTR by sending a request to the data module to modify the VSP holdings field to reflect the new quantity held for each security affected by new LTRs.

Also provided by the present invention in the system is a News and Event Aggregator module (NEAM): NEAM is a software agent that uses web feeds to retrieve syndicated web content such as blogs, pod casts, blogs, analyst reports, corporate action announcements, earnings announcements, and mainstream mass media websites, or in the case of a search aggregator, a customized set of search results for storage in the data module. The BreakingNews sub-module retrieves the most recent available news for the key string from the web and sends it back to the system. iNews module: gathers breaking news articles in real time, from the web. iEdgar module: harvests Financial Data Summaries from SEC 10-k filings, from the EDGAR web site.

Further provided is a VSP ranker module: Here this module obtains VSP Total Value field from the data module, then it obtains VSP Performance data, then obtains VSP age field and compares with VSPs in the database and compiles a ranking list based on a set of user selected parameters. The system then gives a ranking to all the participants of a competition based on their returns. Rankings may take into consideration the risk factor involved, and/or any other set of portfolio-level criteria whose selection and relative weights are selected by the user.

Also the invention can have a VSP analyzer basically performs performance assessment, risk assessment, industry distribution, rule derivation, uses genetic programming algorithms to attempt to derive rules that predict a particular contributor's trade behavior (Buy, Sell, or Hold) as a function of various quantified securities data, which including: a) Security value in dollars, b) Beta of the security and c) Event information from the NEAM.

Also provided is an automatic trade emulation feature. The feature allows subscribers to automatically replicate the trades in their own investment accounts, based on preset parameters that the subscriber selects at the outset of the automation period.

Likewise, subscribers to a particular VSP can subsequently create a VSP that is derived from that original VSP, possibly with modifications made by the subscriber, resulting in progeny VSPs that have the potential to “evolve” new market-beating strategies.

In yet one other embodiment, the present system invention also includes a presentation module which includes the following presentation sub module. The first one is a Profile Management sub-module. It presents 1) Editable list of user's contact network in a grid forma, 2) Editable personal information about the user, 3) Portfolio Content Management Page, 4) Input field(s) for collection of pertinent information on trading strategies, 5) Input field(s) for querying stock symbols and company information, 6) Input form for updating desired securities, quantity and type of position, long/short, in the portfolio, and 7) Field for adding portfolio to an existing or new investment club.

The second one is the Portfolio Subscription Management sub-module. The sub module provides the following: 1) Customizable input form for listing VSP for subscription. Each subscription package consists of four fields: VSP subscription package name, duration, and total price.

The third one is the Account Management sub-module, it presents the following: 1) Users can view their subscription history and manage/edit status of active subscriptions in a tabulated grid format, 2) Input form for Credit Card authorization or Direct Bank Account link setup, 3) Input form for withdrawal of remaining system account balance.

The fourth one is the Portfolio Discovery sub-module which presents 1) Customizable search form for finding users and portfolios, 2) Subsequent searches can be performed on resultant date set, 3) giving users the ability to further drill down and narrow their results, 4) Search parameters created by the user can be saved as query for future searches, 5) Search results will be displayed in a sortable data grid. Users can select the number of columns and their type of data from an available list of predefined categories, and 6) Users can add selected portfolio(s) to their watch list or shopping cart.

An example of the VSP (virtual securities portfolio) is also disclosed here. The module can include 1) Holdings field which includes a) Names of securities included in the VSP, b) Number of shares (or fractional shares) held in each of the named securities. And c) Categorized by industry, 2) Total Value field which includes Per Share Price field: Total Value Aggregate current market value of the VSP's Holdings, 3) Age field: (Time since inception date), 4) Performance History which includes Returns information: a) Since Inception, b) Cumulative, c) Annualized and d) By Sector, 4) Derived Rules: Received from the VSP Analyzer Pedigree & Influences: The Pedigree field shows the genealogy of the VSP, as a time labeled list of VSPs to which the Contributor used to subscribe and which were used as a basis for the contributor's own VSP.

One example of how is a VSP created is that each VSP begins with a set amount of virtual cash (in one embodiment, this is $100,000). Another example of how a VSP created in exact duplication based on verification by the operator of the system that the contributor holds the same amount of cash and securities in their online brokerage trading account.

The VSP can track actual stocks and Mutual Funds listed on NASDAQ, NYSE and AMEX exchanges. Other aspects of VSP include 1) an existing subscriber may become a contributor, 2) a visitor may become a contributor, 3) an existing contributor may become a subscriber, and or 4) a visitor may become a subscriber. Likewise, the invention allows subscribers to a VSP, as well as the contributor of the VSP to track its gains and losses in real-time. Optionally, these users may track any VSP's holdings in separate lots, displaying each block of shares purchased as a separate line in the VSP display. This option provides the most detailed picture of a contributor's holdings and gains; active traders might choose this system. Alternatively, the subscriber or contributor may choose to view all holdings of a security together as a single line item; in this mode, the VSP Display will reflect the average purchase price for all shares, with each security on a separate line. This method allows users to track a running total of current positions, rather than individual transactions; this option may work best for long-term investors, mutual fund owners, or those who participate in a dividend reinvestment plan (DRIP), and want to see the big picture only.

A contributor can log in and view their VSP at any time. The invention will give a contributor all the information on how each one their stocks is doing in the market—any % change in prices during the day, their loss/gain due to each stock. Contributors can keep track of their purchasing power which is the one hundred thousand dollars of virtual cash a contributor get at the inception of the VSP. Available cash in the VSP earns interest at the risk-free rate, which will vary depending on prevailing market conditions. This money market rate is usually around 4-6%. VSPs can be reset, but the system records this event and resets the VSP Age to zero.

In one embodiment, a portfolio may be purely comprised of other portfolios, and in another embodiment a portfolio is comprised of securities and other portfolios. For example, suppose a subscriber has $100,000 in his trading account, and he follows two contributors C1 (value investor) and C2 (day trader). He can assign 25% of his account to C1, and 5% of his account to C2. These two subscriptions follow the same proportional asset-allocation arrangement that C1 and C2 have proven successful.

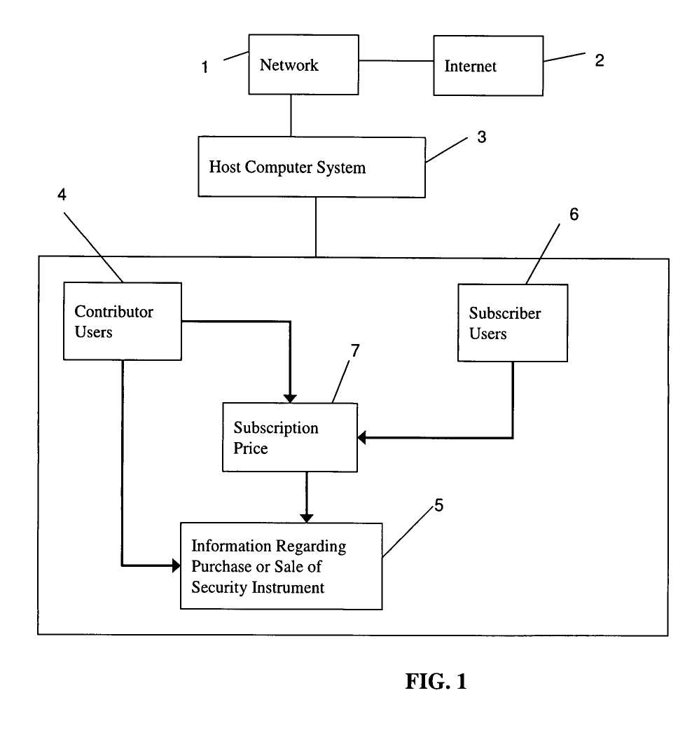

Reference is now made to FIG. 1, which illustrates a diagram of a basic online user to user subscription based marketplace for real-time investment data. In FIG. 1, the diagram discloses a typical embodiment on the present invention. The network 1 can be an internet network 2. A typical internet is a worldwide, publicly accessible series of interconnected computer networks that transmit data by packet switching using the standard Internet Protocol (IP). It is a “network of networks” that consists of millions of smaller domestic, academic, business, and government networks, which together carry various information and services, such as electronic mail, online chat, file transfer, and the interlinked web pages and other resources of the World Wide Web (WWW).

Here the host computer system 3 contains a number of contributor users 4 who provide trading information regarding purchase or sale of security instrument 5 where the information regarding purchase or sale of security instrument 5 is recorded and the contributor users 6 determine a subscription price 7 for subscriber users 6 to access the information regarding the contributors' history and portfolio of purchase or sale of security instrument 5.

Here the subscriber users 6 pay the contributor user determined subscription price 7 and then the subscriber users 6 is able to access the information regarding the contributors' history and portfolio of purchase or sale of security instrument 5.

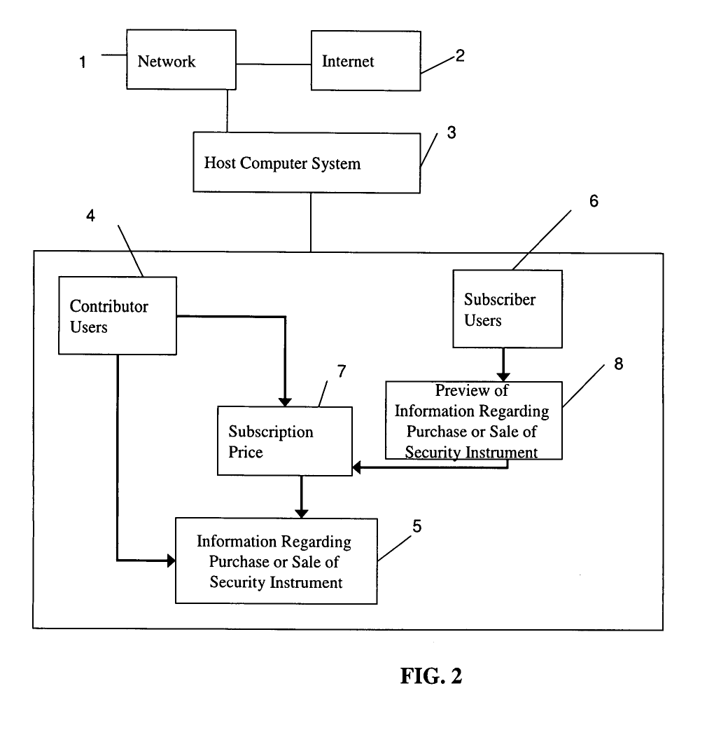

In FIG. 2, the network 1 is an internet network 2 and the host computer 3 is connected to the network 2.

Here the host computer system 3 contains a number of contributor users 4 who provide trading information regarding purchase or sale of security instrument 5 where the information regarding purchase or sale of security instrument is recorded and the contributor users 4 determine a subscription price 7 for subscriber users 6 to access the information regarding the contributors' history and portfolio of purchase or sale of security instrument 5.

The subscriber users 6 can first preview the information regarding the contributors' history and portfolio of purchase or sale of security instrument 8. The subscriber users 6 cannot see the detail of the information regarding the contributors' history and portfolio of purchase or sale of security instrument 5 but rather the subscriber users 6 can see the ranking of the contributor user's portfolio as compared to all the other contributor users in terms of return on investment or the likes. Likewise, ranking can be based on various other attributes such as risk factors, investment goal, and industry sectors or the likes.

After the subscriber users 6 preview the information regarding the contributor users' history and portfolio of purchase or sale of security instrument information 8, the subscriber users 6 can then decide whether to pay the subscription price 7 to access the full information regarding the contributors' history and portfolio of purchase or sale of security instrument 5.

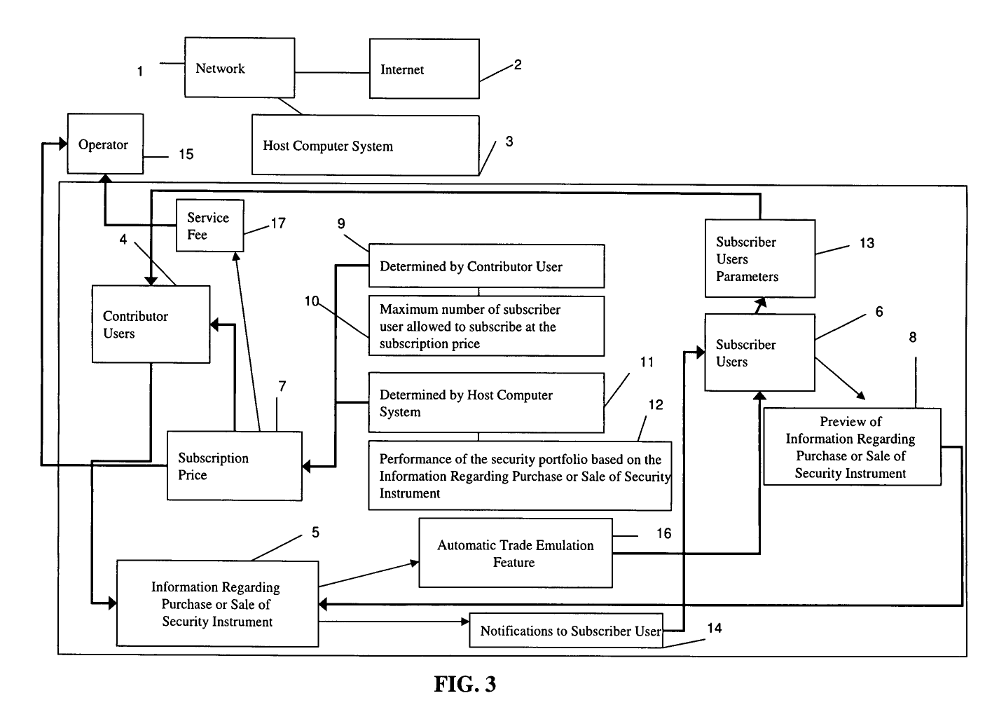

In FIG. 3, another embodiment of the system in FIG. 2 is disclosed. Here network 1 is an internet network 2 and the host computer 3 is connected to the network 2.

Here the host computer system 3 contains a number of contributor users 4 who provide trading information regarding purchase or sale of security instrument 5 where the information regarding purchase or sale of security instrument is recorded. Further included is a subscription price 7 and in one embodiment, the contributor users 4 determine the subscription price 7 for subscriber users 6 to access the information regarding the contributors' history and portfolio of purchase or sale of security instrument 5. In another embodiment, the contributor users 4 determine the subscription price 7 and a maximum number of subscriber user allowed to subscribe at the subscription price 10 for subscriber users 6 to access the information regarding the contributors' history and portfolio of purchase or sale of security instrument 5. In another embodiment, the host computer system 11 determines the subscription price 7. In another embodiment, the host computer system determines the subscription price based on the performance of the securities portfolio based on the contributor's information regarding purchase or sale of security instrument 16. The performance factor can be based on return on investment, return on investment over a certain period, the return on investment as compared to other contributor user's return on investment and any other factors of the likes. In another embodiment, the subscriber users are automatically matched by the host computer system 3 to the contributor users based one the subscriber users' pre-determined parameters such as risk factor, return on investment, or the likes. In another preferred embodiment, the subscriber users 6 are notified by the host computer system 3 via notifications 14 whenever there are changes to the information regarding purchase or sale of security instrument 5. The notifications 14 can be in the form of email, SMS, voice mail, or the likes. In yet another preferred embodiment, the system includes one or more operators 15 who operate the user to user subscription based online marketplace for investment data where the operator 15 receives a percentage of the subscription price 7. In yet one more embodiment, the operator 15 can receive a service fee 17 from the contributor users 4. The service fee 17 can be based on the numbers of subscriber users 6 subscribing to the contributor user or it can be based on a pre-determined flat fee. In yet one more form of embodiment, the system provides an automated trade emulation feature 16 where the feature automatically duplicates trade for the subscriber users according to the contributor users' information regarding purchase or sale of security instrument 5. This can be achieved by the subscriber users providing login information to the feature and the feature automatically login to the subscriber users' online trading account or it can be achieved where the feature communicate to the subscriber users' online brokerage service via an application programming interface or the likes.

In yet another embodiment, the subscriber users 6 can first preview the information regarding the contributors' history and portfolio of purchase or sale of security instrument 8. The subscriber users 6 cannot see the detail of the information regarding the contributors' history and portfolio of purchase or sale of security instrument 5 but rather the subscriber users 6 can see the ranking of the contributor user's portfolio as compared to all the other contributor users in terms of return on investment or the likes. Likewise, ranking can be based on various other attributes such as risk factors, investment goal, and industry sectors or the likes.

After the subscriber users 6 preview the information regarding the contributor users' history and portfolio of purchase or sale of security instrument information 8, the subscriber users 6 can then decide whether to pay the subscription price 7 to access the full information regarding the contributors' history and portfolio of purchase or sale of security instrument 5.

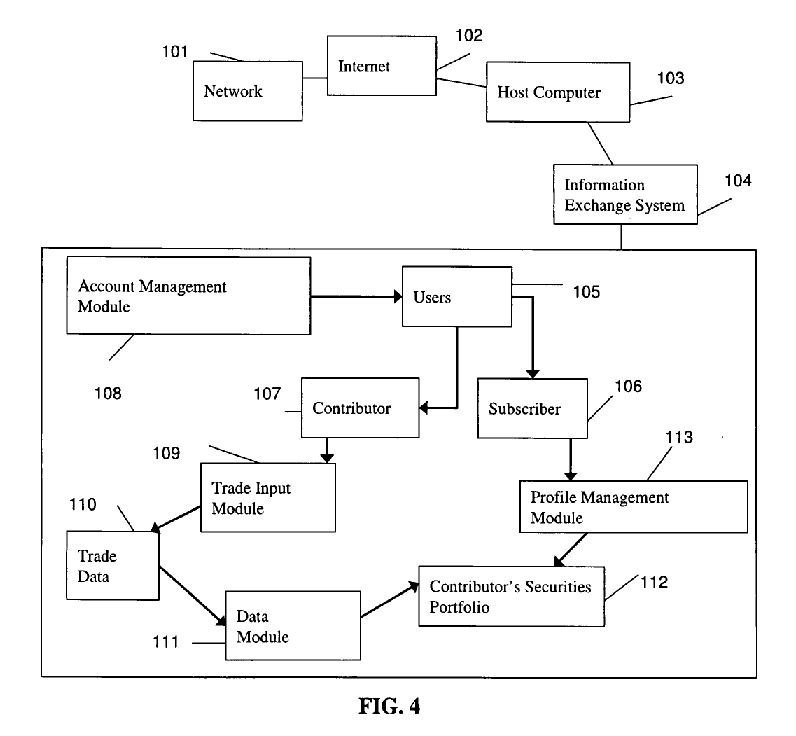

In FIG. 4, another embodiment of the present invention is disclosed. Here is a schematic diagram of the invention where the system to facilitate a user to user subscription based online marketplace for investment data includes a network 101. A network 101 can be an internet network 102. Here the host computer system 103 contains an information exchange system, in the information exchange system 104 there are a number of users 105, users can decide if they want to be a subscriber 106 who pays to view a contributor's securities portfolio 112 ( trading information regarding the purchase or the sale of securities.

On the other hand, users 105 can also become a contributor 107. A contributor 107 is a user who provides information regarding his trading of purchase and sale of security instrument to the exchange system 104. This information is collectively referred as the contributor's securities portfolio 112. Included in the system is an account management module 108. An account management module manages the users' information, such as billing information, account login, history of purchase and so forth.

Further provided is a trade input module 109. The trade input module provides features for the contributor to input the trade data 110. The trade input module 109 then transmits the trade data 110 to a data module 111. The data module then updates the contributor's securities portfolio 112 based on the information provided in the trade data.

Further provided is a profile management module 113. The profile management module 113 provides various features of ranking the contributor's securities portfolio. The ranking can be based on different attributes and there are various methods to which the profile management module can utilize to compare the portfolios.

In one embodiment, the information exchange system hosted by the host computer system can be built utilizing PHP3 script language and MySQL database system. PHP (PHP: Hypertext Preprocessor) is a computer scripting language, originally designed for producing dynamic web pages. It is mainly used in server-side scripting, but can be used from a command line interface or in standalone graphical applications. MySQL is a multithreaded, multi-user SQL database management system (DBMS). The program runs as a server providing multi-user access to a number of databases. Nevertheless, it is appreciated by persons skilled in the art that many different database applications and script languages can be utilized to build the information exchange system.

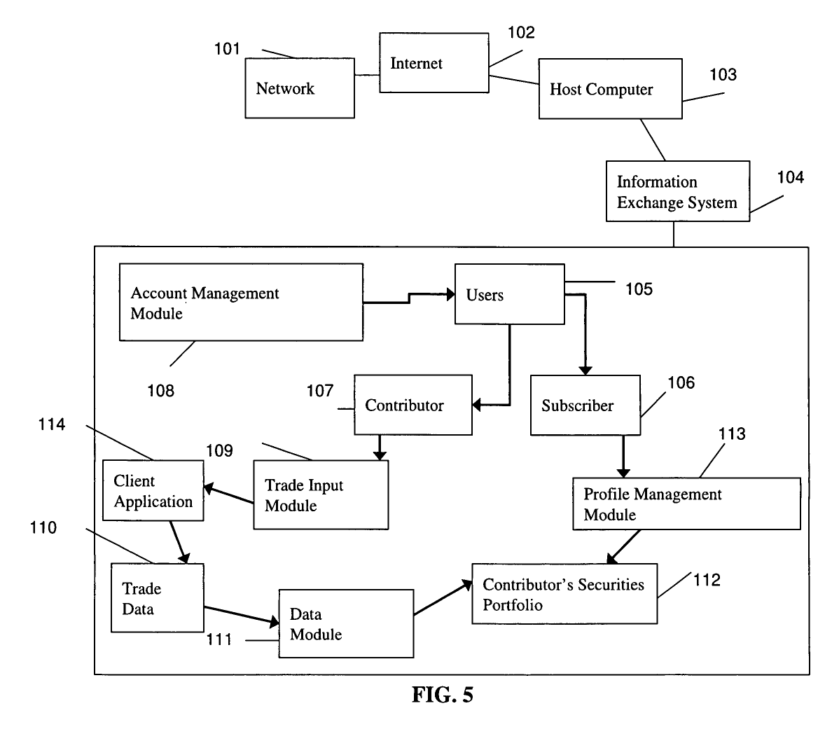

In FIG. 5, the same system of FIG. 3 is disclosed except that here the input module 109 is disclosed to include a client application 114 installed at a contributor's 107 workstation where the client application 114 automatically retrieves the trade data from the website of contributor's online trading brokerage service and transmits the trade data 110 to the data module 111 where the data module can update the contributor's securities portfolio 112 based on the trade data 110. In one embodiment, the contributor can provide their login information directly to the client application 114 and the client application 114 is able to automatically retrieve the trade data 110 from the contributor's 107 online brokerage service using the login information. In another embodiment, the client application 114 is a server application that can automatically retrieve the trade data 110 from the contributor's 107 online brokerage service through the online brokerage service's application programming interface.

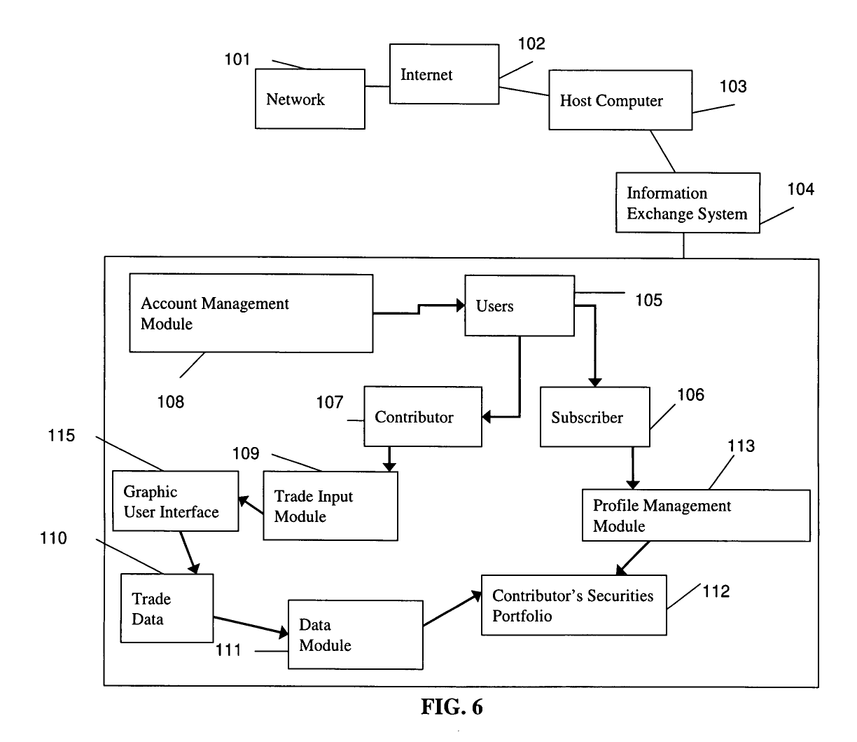

FIG. 6 discloses the same system of FIG. 3, except that the trade input module 109 is comprised of a manual feature where the contributor can manually inputs each of the trade through the graphic user interface 115.

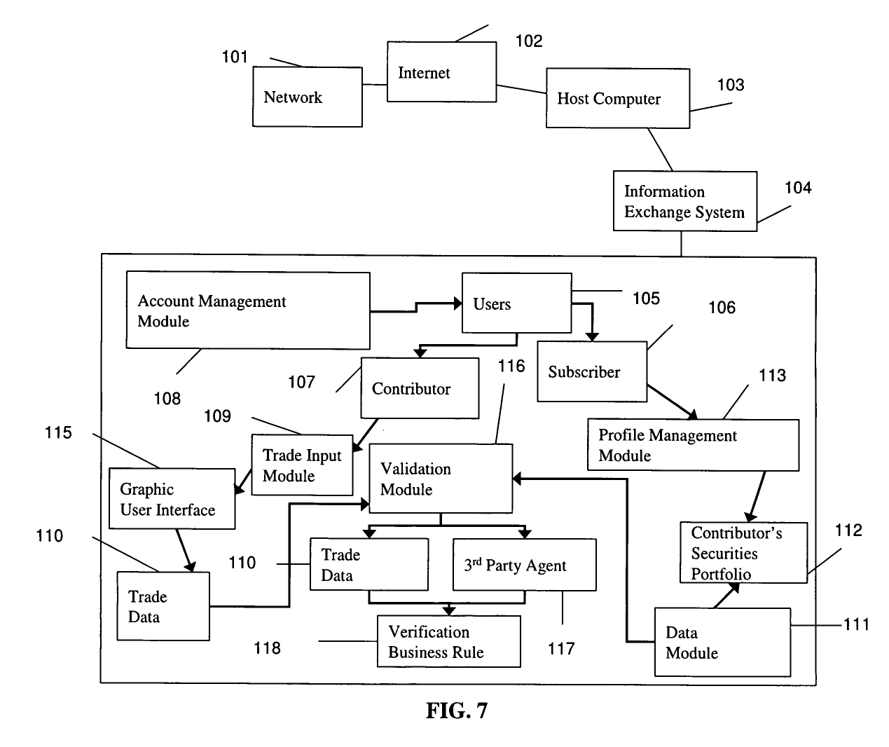

FIG. 7 discloses the same system of FIG. 5 except that for the addition of the validation module 116. In the system disclosed, the validation module 116 utilizes the trade data 110, a 3d party agent 117 that is capable of retrieving real-time security pricing and a verification business rule 118 to determine whether the trade data 110 provided by trade input module 109 is valid.

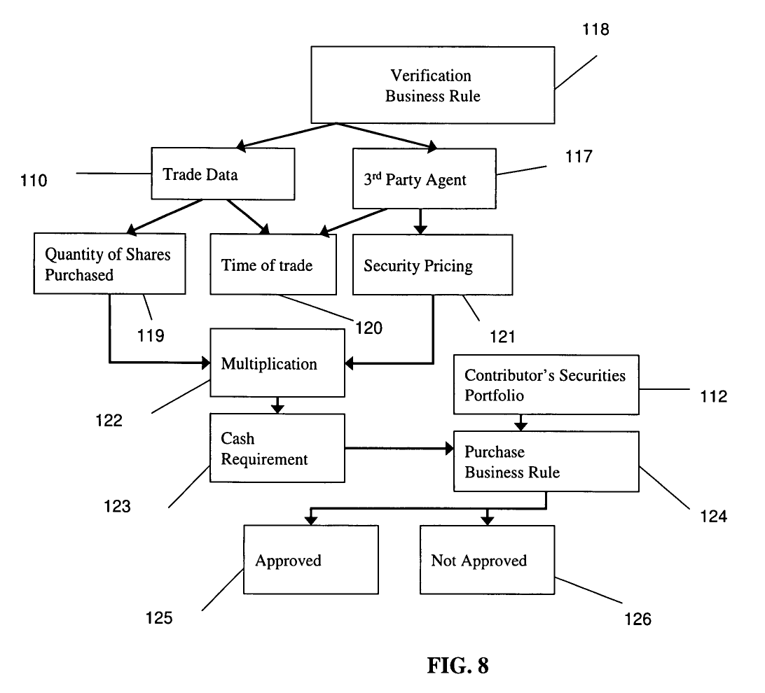

In FIG. 8, the verification business rule 118 of FIG. 6 is further disclosed in detail. As one embodiment of the business rule, using the trade data 110, a quantity of the shares purchased 119 is determined, the trade data 110 would also provide the time of trade 120. Next the 3rd party agent 117 which is capable of retrieving real-time securities pricing information would provide the securities pricing based on the indicated time of trade 120. Then the quantity of shares 119 is multiplied 122 to the security pricing 121 determined at the time of trade by the 3rd party agent 117 based on the retrieved real-time securities pricing information. Based on the multiplication 122, a cash requirement 123 is determined. This cash requirement 123 then is compared to the contributor's securities portfolio 112. Utilizing to a purchase business rule 124, the verification business rule determines whether the trade data 110 is valid or not. If the trade data 110 is valid, the trade data 110 is approved 125. If the trade data 110 is not valid, the trade data 110 is not approved 126. An example of a purchased business rule 124 would be to determine whether there is sufficient cash left in the contributor's securities portfolio 112 to execute the purchase indicated in the trade data 110. In another embodiment, the purchase business rule would be able determine whether there is sufficient margin buying power in the contributor's securities portfolio 112 to execute the trade.

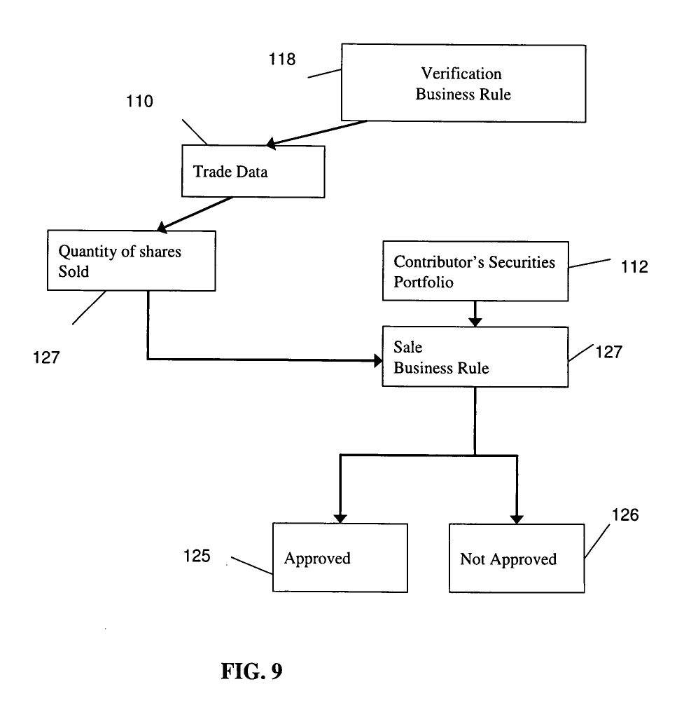

In FIG. 9, another embodiment of a verification business rule 118 is presented. Here the trade data 110 provides for a quantity of shares sold 127 and the information is compared with the contributor's securities portfolio 112, using a sale business rule 127 to determine if the trade a sale of security instrument is valid. If the trade data 110 is valid, the trade data 110 is approved 125. If the trade data 110 is not valid, the trade data 110 is not approved 126. In one example the sale business rule 127 rejects the sale of the security instrument if the contributor's securities portfolio 112 does not contain sufficient shares of the security instrument. In this embodiment, if there are sufficient shares of the security instrument in the portfolio, the sale trade is approved 125.

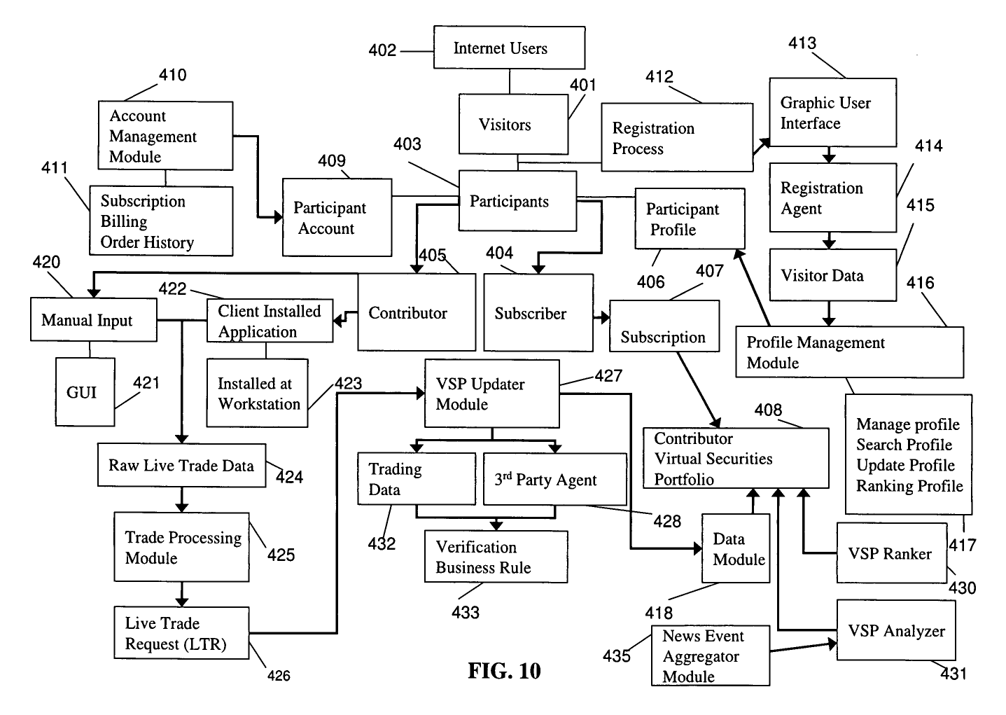

In FIG. 10, another embodiment of a system of the present invention is presented. Here the visitors 401 are internet users 402 who access the present invention via the Internet. A visitor 401 who has completed the registration process 412 is a participant 403. A participant 403 may be a subscriber 404, a contributor 405, or both. Each participant 403 owns a participant profile 406. A participant 403 who may have an active subscription 407 linked to one or more contributor VSPs (Virtual securities portfolio) 408. A VSP provides information regarding purchase or sale of security instrument wherein said information regarding purchase or sale of security instrument is recorded. Each subscriber 404 is associated with a unique participant profile 406 and a unique participant account 409. Participant 403 who owns and manages a contributor VSP 408 is a contributor 405. Each contributor 405 is associated with a unique participant profile 406, a unique participant account 409, and at least one contributor VSP 408. Participant account 409 is managed by account management module 410 which manages subscription, billing and order history or the likes 411. As visitor enters the system, visitors must undergo the registration process 412 which is comprised of visitors 401 entering user information through the graphic user interface 413 and the registration agent 414 collects the visitor data 415 and sends the data 415 to a profile management module 416.

The profile management module 416 manages participant profile 406 which includes the functions of managing profile, searching profile, updating profile, ranking profile, and preview profile 417. Specifically, it includes a) registration of new participants, b) creation and deletion of participant profiles, c) modification of participant profiles, d) searching of participant profiles, automatic update of participant profiles, including: (1) RSS feed-based update of Blog, and (2) VSP preview which includes (A) “Similarity to Visitor” indicators, which shows how similar the holdings, risk ratings, and stated goals of the participant's VSP are to those of the visitor viewing the profile. (B) Shows the rank of the participant's VSP compared to all VSPs in the system's universe, as of the time the visitor views the profile. (C) Shows the rank of the participant's VSP compared to a set of VSP's defined by contributor-chosen parameters. (D) Shows the performance of the particular VSP as compared to any visitor-selected set of VSPs, including predefined VSPs that reflect the DJIA, S&P 500, and other benchmarks.

There are two ways to which a contributor 405 can provide trade information so it may be updated to the contributor virtual securities portfolio (VSP) 408. The first method is through a feature of manual input 420. Here the contributor 405 inputs trading information regarding the purchase or sale of security instrument through the graphic user interface 421. The second method is by automatic feeds. This is achieved through a client installed application 422. The client installed application 422 is installed on each of contributor's remote station 423 to allow for automatic update of the contributor's VSP 408. This is achieved by having the data securely read from the input fields of the graphic user interface of the contributor's 405 online brokerage service as it is entered by the contributor 405. This can be done by an HTML parser. In another embodiment, this may be achieved by the client application utilizing the online brokerage service's application programming interface.

The information retrieved from both methods is raw live data 424 which is processed by the trade processing module 425. The trade processing module 425 processes raw live trade data 424 by associating each trade with the following metadata to create a Live Trade Request (LTR) 426 which may contain: a) Contributor Identifier, b) Source (automatic or manual), c) Action (Buy or Sell), d) Security traded, e) Quantity traded (in shares or fractional shares), f) Effective time of trade. Then the Live Trade Request (LTR) 426 is sent to the VSP updater module 427 in order of the effective time of trade or the likes.

The VSP updater module 427 receives LTR 426 from the trade processing module 425. The module acts as a validation module and attempts to verify the LTR's 426 validity by using (1) information retrieved from a 3d party agent 428, which is capable to retrieving real-time securities pricing information, (2) trade data 432 provided by the LTR 426, and (3) a verification business rule 433 to determine the LTR's 426 validity.

Specifically, it evaluates a Buy LTR by retrieving real-time securities price information from the iYahoo agent or other 3d party agent 428 capable of collecting such information from the web, for the effective time of the LTR 426, and then multiplies the quantity by the security price to determine the cash requirement, which is appended as metadata to the Buy Live trade request. It then compares the cash requirement to the value in the VSP available cash to determine whether the VSP 408 has sufficient virtual funds to execute the Buy LTR.

It also can verify a Sell LTR by determining the quantity of shares in the VSP 427 for the LTR' s 426 specified security, to determine whether the VSP 408 has sufficient shares of the security to execute the Sell LTR.

If the LTR 426 is invalid, for example because it calls for the sale of a security that is not part of the VSP 408, or exceeds the quantity of the security reflected in the VSP 408, the VSP updater module 427 performs the following steps: a) sends a “failed trade” notification to the graphic user interface 421, b) ignores the invalid LTR 426 and also takes one of the following steps according to contributor-specified error handling settings, thus: (1) attempts to process all subsequent LTRs 426 as usual, (2) attempts to process only subsequent LTRs 426 that affect other securities. When a Buy LTR fails due to lack of virtual funds in the VSP 408, it suspends processing of all subsequent Buy LTRs until one or more Sell LTRs are processed whereby resulting in a sufficient amount of virtual funds to complete the failed Buy LTR.

If the LTR is valid, the VSP updater module 427 processes the valid LTR by sending a request to the data module 418 to modify the VSP 408 to reflect the new quantity held for each security affected by new LTRs.

Further provided is a VSP ranker module 430: in one embodiment, the module obtains a VSP total value, some VSP performance data, a VSP age data from the data module 418 and compares with other VSPs 408 in the database and compiles a ranking list based on a set of user selected parameters. The system then gives a ranking to all the participants of a competition based on their investment returns. Rankings may take into consideration the risk factor involved, and/or any other set of portfolio-level criteria whose selection and relative weights are selected by the user.

Also the system can have a VSP analyzer 431 which performs the tasks of performance assessment, risk assessment, industry distribution, rule derivation using genetic programming algorithms to attempt to derive rules that predict a particular contributor's trade behavior (Buy, Sell, or Hold) as a function of various quantified securities data, which including: a) security value in dollars, b) beta of the security and c) event information from the new event aggregator module 435. News event aggregator module is a software agent that uses web feeds to retrieve syndicated web content such as blogs, pod casts, blogs, analyst reports, corporate action announcements, earnings announcements, and mainstream mass media websites, or in the case of a search aggregator, a customized set of search results for storage in the Data module.

Genetic programming is a branch of genetic algorithms. The main difference between genetic programming and genetic algorithms is the representation of the solution. Genetic programming creates computer programs in the lisp or scheme computer languages as the solution. Genetic algorithms create a string of numbers that represent the solution. Genetic programming uses four steps to solve problems: 1) Generate an initial population of random compositions of the functions and terminals of the problem (computer programs). 2) Execute each program in the population and assign it a fitness value according to how well it solves the problem. 3) Create a new population of computer programs: i) Copy the best existing programs, ii) Create new computer programs by mutation, iii) Create new computer programs by crossover (sexual reproduction). 4) The best computer program that appeared in any generation, the best-so-far solution, is designated as the result of genetic programming.

It is appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art. All the embodiments and limitations as descried in the application in singular terms shall not be limited to construe as singular and can be in the form of pularity. Likewise, all the embodiments and limitations as descried in the application in pularity terms shall not be limited to construe as pularity and can be in the form of singular.

1. A method to facilitate a user to user subscription based online marketplace for investment data comprising:
a. providing a network,
b. providing a host computer system wherein said host computer system is connected to said network wherein said host computer system contains one or more contributor users wherein said contributor user provides information regarding purchase or sale of security instrument wherein said information regarding purchase or sale of security instrument is recorded,
c. providing a subscription price wherein said contributor user receives said subscription price,
d. providing one or more subscriber users wherein said subscriber user pays said subscription price to access said information regarding purchase or sale of security instrument.

2. The method of claim 1 wherein the network in an internet network.

3. The method of claim 1 wherein said subscriber user can preview said information regarding purchase or sale of security instrument before said subscriber user pays said subscription price to access said information regarding purchase or sale of security instrument.

4. The method of claim 1 wherein said subscription price is determined by said contributor user.

5. The method of claim 1 wherein said subscription price is determined by said contributor user wherein a maximum number of subscriber users allowed to subscribe by paying said subscription price is determined by said contributor user.

6. The method of claim 1 wherein said subscription is determined by said host computer system.

7. The method of claim 1 wherein said subscription is determined by said host computer system based on said information regarding purchase or sale of security instrument.

8. The method of claim 1 wherein said subscriber user is automatically matched by said host computer system to said contributor user based on said subscriber user's predetermined parameters.

9. The method of claim 1 wherein said subscriber user is notified by said host computer system when said information regarding purchase or sale of security instrument is recorded.

10. The method of claim 1 further comprising providing an operator wherein said operator operates said user to user subscription based online marketplace for investment data wherein said operator receives a percentage of the subscription price.

11. The method of claim 1 further comprising providing an operator wherein said operator operates said user to user subscription based online marketplace for investment data wherein said operator receives a service fee from said contributor user.

12. The method of claim 1 further comprising:
a. providing an automated trade emulation feature wherein said automated trade feature automatically duplicates trade for said subscriber user based on said information regarding purchase or sale of security instrument.

13. A system to facilitate a user to user subscription based online marketplace for investment data comprising:
a. a network,
b. a host computer system wherein said host computer system is connected to said network wherein said host computer system contains one or more contributor users wherein said contributor user provides information regarding purchase or sale of security instrument wherein said information regarding purchase or sale of security instrument is recorded,
c. a subscription price wherein said contributor user receives said subscription price,
d. one or more subscriber users wherein said subscriber user pays said subscription price to access said information regarding purchase or sale of security instrument.

14. The system of claim 13 wherein the network is an internet network.

15. The system of claim 13 wherein said subscriber user can preview said information regarding purchase or sale of security instrument before said subscriber user pays said subscription price to access said information regarding purchase or sale of security instrument.

16. The system of claim 13 wherein said subscription is determined by said contributor user.

17. The system of claim 13 wherein said subscription price is determined by said contributor user wherein a maximum number of subscriber users allowed to subscribe by paying said subscription price is determined by said contributor user.

18. The system of claim 13 wherein said subscription is determined by said host computer system.

19. The system of claim 13 wherein said subscription is determined by said host computer system based on said information regarding purchase or sale of security instrument.

20. The system of claim 13 wherein said subscriber user is automatically matched by said host computer system to said contributor user based on said subscriber user's predetermined parameters.

21. The system of claim 13 wherein said subscriber user is notified by said host computer system when said information regarding purchase or sale of security instrument is recorded.

22. The system of claim 13 further comprising an operator wherein said operator operates said user to user subscription based online marketplace for investment data wherein said operator receives a percentage of the subscription price.

23. The system of claim 13 further comprising an operator wherein said operator operates said user to user subscription based online marketplace for investment data wherein said operator receives a service fee from said contributor user.

24. The system of claim 13 further comprising:
a. an automated trade emulation feature wherein said automated trade feature automatically duplicates trade for said subscriber user based on said information regarding purchase or sale of security instrument.

25. A system to facilitate a user to user subscription based online marketplace for investment data comprising:
a. a network
b. one or more users
c. one or more contributors wherein said contributors is an user wherein said contributor manages a securities portfolio,
d. a subscription price wherein said contributor receives said subscription price,
e. one or more subscribers wherein said subscriber is an user wherein said subscriber pays said subscription price to access said contributor's securities portfolio,
f. a host computer system wherein said host computer system is connected to said network wherein said host computer system hosts an information exchange system comprising:
1. an account management module wherein said account management module manages said user's information,
2. a profile management module wherein said profile management module provides preview information regarding said contributor's securities portfolio regarding purchase or sale of security instrument,
3. a data module wherein said data module updates said contributor's securities portfolio,
4. an input module wherein said trade input module provides contributor's trading data regarding said contributor's purchase or sale of security instrument to said data module.

26. The system of claim 25 wherein said input module is comprised of a graphic user interface wherein said contributor enters said contributor's trading through said graphic user interface.

27. The system of claim 25 wherein said input module is comprised of a client application installed at said contributor's work station wherein said client application retrieves input fields of said contributor's online brokerage service.

28. The system of claim 25 further comprising a validation module wherein said validation module validates said trading data is provided to said data module.

29. The system of claim 28 wherein said validation module is comprised of:
a. contributor's trading data,
b. a third party agent capable of collecting real-time security price information,
c. a verification module wherein said verification module verifies said contributor's trading data using said real-time security price information and a verification business rule.

30. The system of claim 29 wherein said verification business rule is comprised of:
a. retrieving a quantity of security shares purchased from said trading data,
b. retrieving time of trade from said trading data,
c. determining security pricing at said time of trade using security price information provided by said third party agent,
d. multiplying said quantity of security shares purchased by said security price determined by third party agent at said time of trade to determine a cash requirement,
e. comparing said cash requirement to said contributor's securities portfolio to determine whether said contributor's securities portfolio has sufficient funds to execute said purchase of quantity of security shares.

31. The system of claim 29 wherein said verification business rule is comprised of:
a. retrieving a quantity security of shares sold from said trading data,
b. comparing said quantity of shares sold with said contributor's securities portfolio to determine whether said contributor's securities portfolio has sufficient shares to execute said sale of quantity of security shares.

32. The system of claim 25 further comprises a news updating module.

33. The system of claim 25 wherein said preview information is comprised of:
a. providing ranking information regarding said contributor's securities portfolio as compared to other contributor's securities portfolio,
b. providing risk ratings regarding said contributor's securities portfolio,
c. providing security holding summary regarding said contributor's securities portfolio,
d. providing investment summary regarding contributor's securities portfolio.

34. The system of claim 25 further comprises providing portfolio ranking module.

35. The system of claim 25 further comprises providing portfolio analysis module.

36. The system of claim 25 wherein said wherein said subscription price is determined by said contributor.

37. The system of claim 25 wherein said subscription price is determined by said contributor wherein a maximum number of subscribers allowed to subscribe by paying said subscription price is determined by said contributor.

38. The system of claim 25 wherein said subscription is determined by said host computer system.

39. The system of claim 25 wherein said subscription is determined by said host computer system based on said contributor's securities portfolio.

40. The system of claim 25 wherein said subscriber is automatically matched by said host computer system to said contributor based on said subscriber's predetermined parameters.

41. The system of claim 25 wherein said subscriber is notified by said host computer system when said contributor's securities portfolio is changed.

42. The system of claim 25 further comprising an operator wherein said operator operates said user to user subscription based online marketplace for investment data wherein said operator receives a percentage of said subscription price.

43. The system of claim 25 further comprising an operator wherein said operator operates said user to user subscription based online marketplace for investment data wherein said operator receives a service fee from said contributor.

44. The system of claim 25 further comprising:
a. an automated trade emulation feature wherein said automated trade feature automatically duplicates trade for said subscriber based on changes to said contributor's securities portfolio.

45. A method to facilitate a user to user subscription based online marketplace for investment data comprising:
a. providing a network,
b. providing one or more users,
c. providing one or more contributors wherein said contributors is an user wherein said contributor manages a securities portfolio,
d. providing a subscription price wherein said contributor receives said subscription price,
e. providing one or more subscribers wherein said subscriber is an user wherein said subscriber pays said subscription price to access said contributor's securities portfolio,
f. providing a host computer system wherein said host computer system is connected to said network wherein said host computer system hosts an information exchange system comprising:
1. an account management module wherein said account management module manages said user's information,
2. a profile management module wherein said profile management module provides preview information regarding said contributor's securities portfolio regarding purchase or sale of security instrument,
3. a data module wherein said data module updates said contributor's securities portfolio,
4. an input module wherein said trade input module provides contributor's trading data regarding said contributor's purchase or sale of security instrument to said data module.

46. The method of claim 45 wherein said input module is comprised of a graphic user interface wherein said contributor enters said contributor's trading through said graphic user interface.

47. The method of claim 45 wherein said input module is comprised of a client application installed at said contributor's work station wherein said client application retrieves input fields of said contributor's online brokerage service.

48. The method of claim 45 further comprising a validation module wherein said validation module validates said trading data is provided to said data module.

49. The method of claim 48 wherein said validation module is comprised of:
a. contributor's trading data,
b. a third party agent capable of collecting real-time security price information,
c. a verification module wherein said verification module verifies said contributor's trading data using said real-time security price information and a verification business rule.

50. The method of claim 49 wherein said verification business rule is comprised of:
a. retrieving a quantity of security shares purchased from said trading data,
b. retrieving time of trade from said trading data,
c. determining security pricing at said time of trade using security price information provided by said third party agent,
d. multiplying said quantity of security shares purchased by said security price determined by third party agent at said time of trade to determine a cash requirement,
e. comparing said cash requirement to said contributor's securities portfolio to determine whether said contributor's securities portfolio has sufficient funds to execute said purchase of quantity of security shares.

51. The method of claim 49 wherein said verification business rule is comprised of:
a. retrieving a quantity security of shares sold from said trading data,
c. comparing said quantity of shares sold with said contributor's securities portfolio to determine whether said contributor's securities portfolio has sufficient shares to execute said sale of quantity of security shares.

52. The method of claim 45 further comprises providing a news updating module.

53. The method of claim 45 wherein said preview information is comprised of:
a. providing ranking information regarding said contributor's securities portfolio as compared to other contributor's securities portfolio,
b. providing risk ratings regarding said contributor's securities portfolio,
c. providing security holding summary regarding said contributor's securities portfolio,
d. providing investment summary regarding contributor's securities portfolio.

54. The method of claim 45 further comprises providing portfolio ranking module.

55. The method of claim 45 further comprises providing portfolio analysis module.

56. The method of claim 45 wherein said wherein said subscription price is determined by said contributor.

57. The method of claim 45 wherein said subscription price is determined by said contributor wherein a maximum number of subscribers allowed to subscribe by paying said subscription price is determined by said contributor.

58. The method of claim 45 wherein said subscription is determined by said host computer system.

59. The method of claim 45 wherein said subscription is determined by said host computer system based on said contributor's securities portfolio

60. The method of claim 45 wherein said subscriber is automatically matched by said host computer system to said contributor based on said subscriber's predetermined parameters.

61. The method of claim 45 wherein said subscriber is notified by said host computer system when said contributor's securities portfolio is changed.

62. The method of claim 45 further comprising providing an operator wherein said operator operates said user to user subscription based online marketplace for investment data wherein said operator receives a percentage of the subscription price.

63. The method of claim 45 further comprising an operator wherein said operator operates said user to user subscription based online marketplace for investment data wherein said operator receives a service fee from said contributor.

64. The method of claim 45 further comprising:
a. an automated trade emulation feature wherein said automated trade feature automatically duplicates trade for said subscriber based on changes to said contributor's securities portfolio.

65. A method to verify a user's trading information in an online investment community comprising:
a. providing user's trading data,
b. providing a third party agent capable of collecting real-time securities price information,
c. providing a verification module wherein said verification module verifies user's trading data using said real-time security price information and a verification business rule.

66. The method of claim 65 wherein said verification business rule is comprised of:
a. retrieving a quantity of security shares purchased from said user trading data,
b. retrieving a time of trade from said user trading data,
c. determining a security pricing at said time of trade using security price information provided by said third party agent,
d. multiplying said quantity of security shares purchased by said security price determined at said time of trade provided by said third party agent to determine a cash requirement,
e. comparing said cash requirement to said contributor's securities portfolio to determine whether said contributor's securities portfolio has sufficient funds to execute said purchase of said quantity of security shares.

67. The method of claim 65 wherein said verification business rule is comprised of:
a. retrieving a quantity of shares sold from said user's trading data,
b. comparing said quantity of shares sold with said contributor's securities portfolio to determine whether said contributor's securities portfolio has sufficient shares to execute said quantity of security shares.

68. A system to verify a user's trading information in an online investment community comprising:
a. user's trading data,
b. a third party agent capable of collecting real-time securities price information
c. a verification module wherein said verification module verifies user's trading data using said real-time security price information and a verification business rule.

69. The system of claim 68 wherein said verification business rule is comprised of:
a. retrieving a quantity of security shares purchased from said user trading data,
b. retrieving a time of trade from said user trading data,
c. determining a security pricing at said time of trade using security price information provided by said third party agent,
d. multiplying said quantity of security shares purchased by said security price determined at said time of trade provided by said third party agent to determine a cash requirement,
e. comparing said cash requirement to said contributor's securities portfolio to determine whether said contributor's securities portfolio has sufficient funds to execute said purchase of said quantity of security shares.

70. The system of claim 68 wherein said business rule is comprised of:
a. retrieving a quantity of shares sold from said user's trading data,
b. comparing said quantity of shares sold with said contributor's securities portfolio to determine whether said contributor's securities portfolio has sufficient shares to execute said sale of said quantity of security shares.

71. A system to facilitate a user to user subscription based online marketplace for investment data comprising:
a. a network,
b. one or more participants,
c. one or more contributors wherein said contributor is a participant wherein said contributors manages a virtual securities portfolio,
d. a subscription price wherein said contributor receives said subscription price,
e. one or more subscribers wherein said subscriber is a participant wherein said subscriber pays said subscription price to view said virtual securities portfolio,
f. a host computer system wherein said host computer system is connected to said network wherein said host computer system hosts an information exchange system comprising:
1. an account management module wherein said account management module manages said participant's account information,
2. a registration module wherein said registration collects visitor data and transmits said visitor data to a profile management module,
3. a profile management module wherein said profile management module manages said participant's profile,
4. a data module wherein said data module utilizes a trade request to update said contributor's virtual securities portfolio,
5. an input module wherein said trade input module provides contributor's trading data regarding contributor's purchase or sale of security instrument to a trade processing module,
6. a trade processing module wherein said trade processing module process said contributor's trading data to generate a trade request wherein said trade request is transmitted to said data module.

72. The system of claim 71 wherein said input module is comprised of a graphic user interface wherein said contributor enters said contributor's trading data through said graphic user interface.

73. The system of claim 71 wherein said input module is comprised of a client application installed at said contributor's work station wherein said client application retrieves input fields of said contributor's online brokerage service.

74. The system of claim 71 further comprising a news updating module.

75. The system of claim 71 wherein said subscriber can preview said contributor's virtual securities portfolio before paying for said subscription price.

76. The system of claim 71 wherein said subscription price is determined by said contributor.

77. The system of claim 71 wherein said subscription price is determined by said contributor wherein a maximum number of subscribers allowed to subscribe by paying said subscription price is determined by said contributor.

78. The system of claim 71 wherein said subscription price is determined by said host computer system.

79. The system of claim 71 wherein said subscription price is determined by said host computer system based on said virtual securities portfolio.

80. The system of claim 71 wherein said subscriber is automatically matched by said host computer system to said contributor based on said subscriber's predetermined parameters.

81. The system of claim 71 wherein said subscriber is notified by said host computer system when said virtual securities portfolio is changed.

82. The system of claim 71 further comprising an operator wherein said operator operates said user to user subscription based online marketplace for investment data wherein said operator receives a percentage of the subscription price.

83. The system of claim 71 further comprising an operator wherein said operator operates said user to user subscription based online marketplace for investment data wherein said operator receives a service fee from said contributor.

84. The system of claim 71 further comprising:
a. an automated trade emulation feature wherein said automated trade feature automatically duplicates trade for said subscriber based on changes to said virtual securities portfolio.

85. A method to facilitate a user to user subscription based online marketplace for investment data comprising:
a. providing a network,
b. providing one or more participants,
c. providing one or more contributors wherein said contributor is a participant wherein said contributors manages a virtual securities portfolio,
d. providing a subscription price wherein said contributor receives said subscription price,
e. providing one or more subscribers wherein said subscriber is a participant wherein said subscriber pays said subscription price to view said virtual securities portfolio,
f. providing a host computer system wherein said host computer system is connected to said network wherein said host computer system hosts an information exchange system comprising:
1. an account management module wherein said account management module manages said participant's account information,
2. a registration module wherein said registration collects visitor data and transmits said visitor data to a profile management module,
3. a profile management module wherein said profile management module manages said participant's profile,
4. a data module wherein said data module utilizes a trade request to update said contributor's virtual securities portfolio,
5. an input module wherein said trade input module provides contributor's trading data regarding contributor's purchase or sale of security instrument to a trade processing module,
6. a trade processing module wherein said trade processing module process said contributor's trading data to generate a trade request wherein said trade request is transmitted to said data module.

86. The method of claim 85 wherein said input module is comprised of a graphic user interface wherein said contributor enters said contributor's trading data through said graphic user interface.

87. The method of claim 85 wherein said input module is comprised of a client application installed at said contributor's work station wherein said client application retrieves input fields of said contributor's online brokerage service.

88. The method of claim 85 further comprises providing a news updating module.

89. The method of claim 85 wherein said subscriber can preview said contributor's virtual securities portfolio before paying for said subscription price.

90. The method of claim 85 wherein said subscription price is determined by said contributor.

91. The method of claim 85 wherein said subscription price is determined by said contributor wherein a maximum number of subscribers allowed to subscribe by paying said subscription price is determined by said contributor.

92. The method of claim 85 wherein said subscription price is determined by said host computer system.

93. The method of claim 85 wherein said subscription price is determined by said host computer system based on said virtual securities portfolio.

94. The method of claim 85 wherein said subscriber is automatically matched by said host computer system to said contributor based on said subscriber's predetermined parameters.

95. The method of claim 85 wherein said subscriber is notified by said host computer system when said virtual securities portfolio is changed.

96. The method of claim 85 further comprising providing an operator wherein said operator operates said user to user subscription based online marketplace for investment data wherein said operator receives a percentage of the subscription price.

97. The method of claim 85 further comprising an operator wherein said operator operates said user to user subscription based online marketplace for investment data wherein said operator receives a service fee from said contributor.

98. The method of claim 85 further comprising:
a. an automated trade emulation feature wherein said automated trade feature automatically duplicates trade for said subscriber based on changes to said virtual securities portfolio.

99. A method to facilitate a user to user subscription based online marketplace for access of data comprising:
a. providing a network,
b. providing a host computer system wherein said host computer system is connected to said network wherein said host computer system contains one or more contributor users wherein said contributor user provides a set of data,
c. providing a subscription price wherein said contributor user receives said subscription price,
d. providing one or more subscriber users wherein said subscriber user pays said subscription price to access said set of data.

100. The method of claim 99 wherein the network is an internet network.

101. The method of claim 99 wherein said subscriber user can preview said set of data before said subscriber user pays said subscription price to access said set of data.

102. The method of claim 99 wherein said subscription price is determined by said contributor user.

103. The method of claim 99 wherein said subscription price is determined by said contributor user wherein a maximum number of subscriber users allowed to subscribe by paying said subscription price is determined by said contributor user.

104. The method of claim 99 wherein said subscription is determined by said host computer system.

105. The method of claim 99 wherein said subscriber user is automatically matched by said host computer system to said contributor user based on said subscriber user's predetermined parameters.

106. The method of claim 99 further comprising providing an operator wherein said operator operates said user to user subscription based online marketplace for access of data wherein said operator receives a percentage of the subscription price.

107. The method of claim 99 further comprising providing an operator wherein said operator operates said user to user subscription based for access of data wherein said operator receives a service fee from said contributor user.

108. A system to facilitate a user to user subscription based online marketplace for access of data comprising:
a. a network,
b. a host computer system wherein said host computer system is connected to said network wherein said host computer system contains one or more contributor users wherein said contributor user provides a set of data,
c. a subscription price wherein said contributor user receives said subscription price,
d. one or more subscriber users wherein said subscriber user pays said subscription price to access said set of data.

109. The system of claim 108 wherein the network is an internet network.

110. The system of claim 108 wherein said subscriber user can preview said set of data before said subscriber user pays said subscription price to access said set of data.

111. The system of claim 108 wherein said subscription price is determined by said contributor user.

112. The system of claim 108 wherein said subscription price is determined by said contributor user wherein a maximum number of subscriber users allowed to subscribe by paying said subscription price is determined by said contributor user.

113. The system of claim 108 wherein said subscription is determined by said host computer system.

114. The system of claim 108 wherein said subscriber user is automatically matched by said host computer system to said contributor user based on said subscriber user's predetermined parameters.

115. The system of claim 108 further comprising an operator wherein said operator operates said user to user subscription based online marketplace for access of data wherein said operator receives a percentage of the subscription price.

116. The system of claim 108 further comprising an operator wherein said operator operates said user to user subscription based for access of data wherein said operator receives a service fee from said contributor user.
